(19) United States
(12) Patent Application Publication
(10) Pub. No.: US 2005/0022749 A1
(43) Pub. Date: Feb. 3, 2005

(54) Support for the aquaculture, by propagation, of aquatic animals, particularly for aquariums, and installation comprising such a support

(75) Inventor: Frederic Amblard, Mazamet (FR)

Correspondence Address: YOUNG & THOMPSON, 745 SOUTH 23RD STREET, 2ND FLOOR, ARLINGTON, VA, 22202, US

(73) Assignee: AMBLARD OVERSEAS TRADING, MAZAMET (FR)

(21) Appl. No.: 10/869,924

(22) Filed: Jun. 18, 2004

(30) Foreign Application Priority Data
Jun. 20, 2003 (FR) 0307440

(51) Int. Cl. A01K 63/00

(52) U.S. Cl. 119/269

(57) ABSTRACT

The invention proposes a support (10) for the aquaculture, by propagation, of aquatic animals (2), particularly for aquariums, such as cnidarians or poriferans, characterized in that it comprises an upper head (14), for receiving at least one cutting (8), and a lower trunk (16) for fastening the support (10), particularly in a culture installation, or alternatively in a transport container, and in that the trunk (16) can be separated from the head (14) so that the latter then constitutes a base for displaying the cultured animal. The invention also proposes an installation comprising such a support.

The invention relates to a support for the aquaculture, by propagation, of aquatic animals “with roots”, particularly for aquariums, and an installation comprising such a support.

Many live species of aquatic animals are traded internationally, usually so as to acquire specimens for aquariums.

These aquatic animals belong, for example, to the phylum Cnidaria, such as corals, or to the phylum Porifera, such as sponges.

This is one reason why all or part of an adult animal, such as the branches in the case of corals, is often removed from the natural environment, despite the ecological consequences of such action.

Thus, the sea floor, particularly coral beds, suffers as much of it is removed, to the extent that not only the species excessively removed, but also the ecosystem of which it forms part, may be endangered.

Other uses, such as the production of souvenirs from some of these animals, only increase demand and hence the rate of removal.

In order to reduce the rate of removal of aquatic animals from the natural environment and to protect this environment, it is desirable to develop the aquaculture of some of these species.

In the aquaculture of such species, use is made in particular of the technique of propagation or fragmentation, i.e. the artificial multiplication of animals using cuttings. A cutting generally consists of a fragment taken from the “parent” animal, which will then grow until it becomes an animal with the same characteristics as the “parent” animal.

The fragment forming the cutting is generally around a few centimetres in size, which is negligible for a “parent” animal inasmuch as its development is not affected.

Many aquaculture installations that use propagation are already known, but they are not entirely satisfactory.

Specifically, cuttings of aquatic animals are attached for example to wire-type supports, but the animals thus obtained after growth of the cutting must then be detached, and sometimes torn, so that they can be sold.

The animals are thus weakened and may be injured both during the separation from the support and subsequently when they are packaged or transported to intermediaries or a final consignee to be marketed.

In order to solve these problems, the invention proposes a support for the aquaculture, by propagation, of aquatic animals, particularly for aquariums, such as cnidarians or poriferans, characterized in that it comprises an upper head, for receiving at least one cutting, and a lower trunk for fastening the support, particularly in a culture installation, or alternatively in a transport container, and in that the trunk can be separated from the head so that the latter then constitutes a base for displaying the cultured animal.

By virtue of the invention, aquatic animals grown from cuttings are protected from the risk of injury and may be then transported and marketed directly with the display base formed by the head of the culture support.

Advantageously, only a few cuttings of specimens of the species are removed from the natural aquatic environment, and these are cultured so as to create, by successive propagation, a colony that is big enough to subsequently supply the cuttings needed for the aquaculture.

Preferably, the head forming the display base includes a plurality of cavities or grooves in which are propagated animals of different species that can cohabit and develop.

According to other features of the invention:
at least the upper head forming a display base is made of a material similar to mineral;
the top face of the head comprises at least one cavity for receiving at least one cutting of the animal;
the cutting is fastened in the cavity of the head by fastening means, by adhesive bonding, in particular by an epoxy adhesive, a cyanoacrylate or quick-setting cement;
at least the head is made by moulding a mixture of one or more mineral components selected from cement, sand, calcium carbonate, calcium hydroxide, pozzolana, natural rock and pumice stone;
the support comprises connecting means between the upper head and lower trunk to allow their assembly;
on its underside, the head comprises a housing, in particular for receiving the upper end of the lower trunk;
the lower trunk comprises a radial flange, comprising an upper abutment surface that collaborates after assembly with the underside of the head;
the head has the overall shape of a disc whose horizontal underside, from which the trunk extends centrally downwards, subsequently constitutes the underside of the base;
the support comprises a zone of lower mechanical strength at the join between the upper end of the trunk and the head;
it comprises a break initiator at the join between the upper end of the trunk and the head;
at least the head is made by moulding a mixture of one or more mineral components selected from cement, sand, calcium carbonate, calcium hydroxide, pozzolana, natural rock and pumice stone;
the trunk is made by moulding as a single piece using a mixture that is similar but of different density and composition, so as to facilitate the subsequent separation of the trunk from the head.

The invention also proposes an installation for the aquaculture, by propagation, of aquatic animals, particularly for aquariums, such as cnidarians or poriferans, of the type comprising at least one support according to any one of the preceding features, characterized in that it comprises at least one generally horizontal tray that has at least one housing for receiving a trunk of a support.

According to other features of the installation:
the horizontal tray comprises a frame and a grid, each cell of which constitutes a housing for a trunk of a support;
the lower trunk of the support is integral with the horizontal tray;
the horizontal tray comprises legs so as to constitute a culture table;
the legs of the tray comprise means for anchoring the culture table to a floor, such as the sea floor;
the tray constitutes a tray for transporting the cultured aquatic animals.

By virtue of its trunk, which can constitute a grip part, the support can be easily and quickly fitted to the culture tray of the installation, thus forming an integral part of said tray.

Advantageously, the horizontal tray comprising the housings in which the trunks of the supports are received also constitutes a transport tray which can be fitted into a container designed for this purpose, especially with a view to exporting them.

Other characteristics and advantages of the invention will emerge from a reading of the detailed description that follows, for the understanding of which reference will be made to the attached drawings in which:

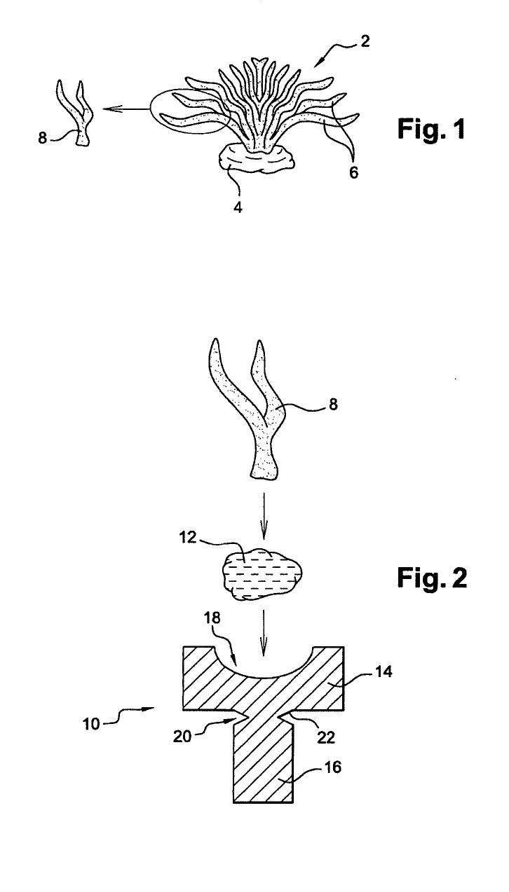

FIG. 1 is a schematic perspective view showing an aquatic animal from a parent colony from which there has been removed a cutting in the form of a fragment to be used for propagation;

FIG. 2 is a view in axial section showing a first embodiment of a culture support according to the invention, before the cutting is fastened in the cavity;

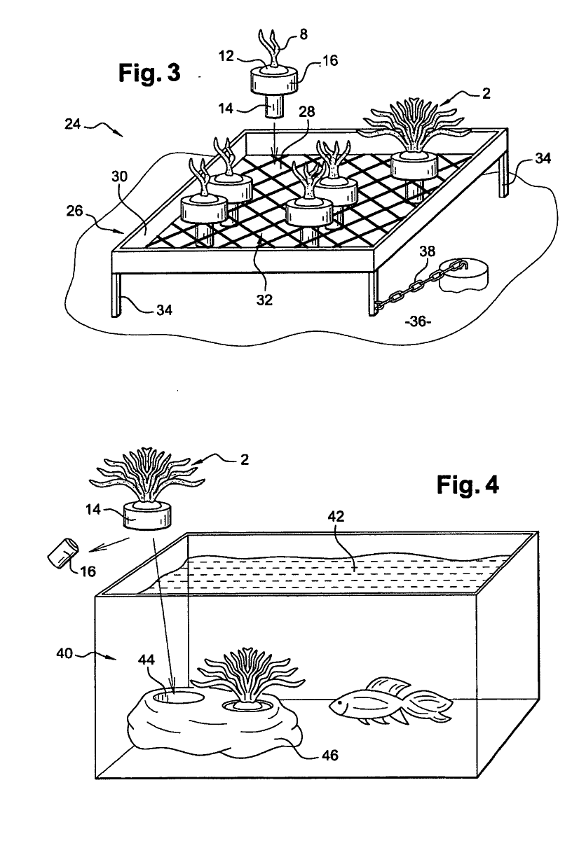

FIG. 3 is a schematic perspective view of an aquaculture installation according to the invention which shows, on the one hand, a support comprising the cutting before the lower trunk is axially inserted into a complementary housing in the horizontal tray of a culture table, and on the other hand, supports whose trunks have already been inserted in housings, which depict (from left to right) aquatic animals at various stages of growth starting from the cutting until a “parent” animal is obtained at the end of culturing;

FIG. 4 is a schematic perspective view of an aquarium comprising on its floor an ornamental rock in a hole of which is received a display base with its aquatic animal, after the head has been separated from the lower trunk of the support according to the invention;

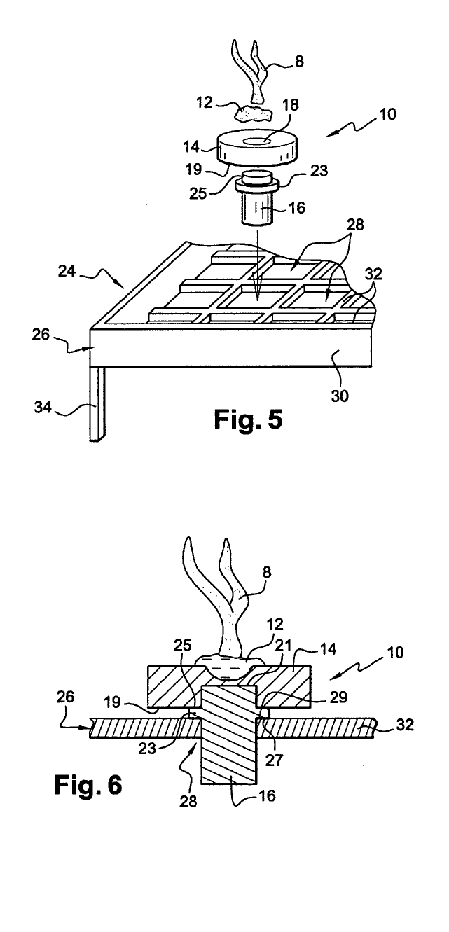

FIG. 5 is a partial schematic perspective view of an aquaculture installation showing an exploded view of a second embodiment of a culture support according to the invention, before the cutting is fastened in the cavity;

FIG. 6 is a partial view in axial section of an aquaculture installation according to FIG. 5, in a housing of which is inserted the lower trunk of a support according to the second embodiment;

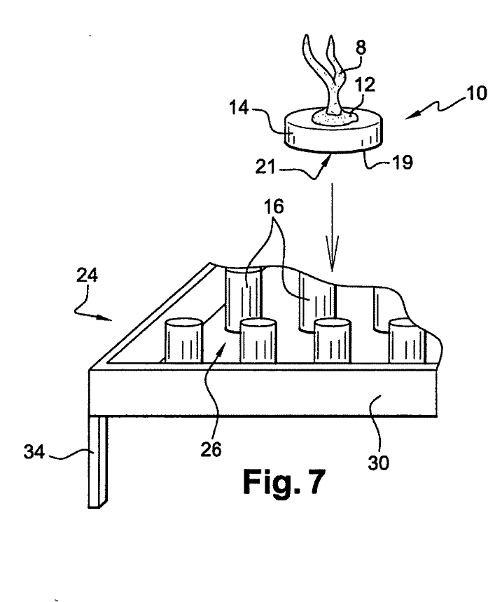

FIG. 7 is a partial schematic perspective view similar to FIG. 5 showing a variant of the second embodiment.

In the description that follows, identical reference numbers identify identical elements or elements fulfilling similar functions.

In order to be able to propagate aquatic animals, one or more fragments must be removed from a “parent” animal, these fragments forming the cuttings needed for the aquaculture.

FIG. 1 shows a “parent” aquatic animal 2, in this case a coral, which is attached to a rock 4 on the sea floor and has branches 6.

Preferably, the aquatic animal 2 comes from a colony that has been cultured beforehand and obtained by successive propagations, in order to limit the removals from the natural environment and to supply thereafter all the cuttings needed for the aquaculture to become established.

To this end, to obtain a cutting 8, a fragment is removed from the end of a branch 6 and the cutting 8 is then fastened to a support 10 like that shown in FIG. 2, according to the first embodiment of the invention.

The cutting 8 is fastened to the support 10 by any appropriate fastening means 12, such as adhesive bonding, in particular using an epoxy adhesive, a cyanoacrylate or quick-setting cement.

The aquaculture support 10 comprises an upper head 14 and a lower trunk 16 for fastening to the support 10.

The head 14 is designed to receive the cutting 8 and for this purpose comprises a cavity 18 open to its top face.

The shape and number of cavities 18 that the head 14 has may vary. The shape of the cavity 18 depends in particular on the type of animal being propagated and on the fastening means 12.

In axial section, the cavity 18 in this case has a generally circular section, which may as a variant be rectangular, and which may extend over all or part of the width of the head 14 forming a groove, for example.

The trunk 16 has the overall shape of a cylinder and the head 14 the shape of a coaxial disc, the trunk 16 being of smaller diameter than the head 14, or as a variant of any other appropriate geometric shape.

Advantageously, the lower trunk 16 constitutes a grip part or handle allowing the support 10 to be manipulated easily.

The support 10 preferably has, at the join between the upper end of the lower trunk 16 and the underside 19 of the head 14, a zone of lower mechanical strength 20.

As can be seen in FIG. 2, the support 10 advantageously has, in the zone 20, a break initiator 22, made for example in the form of an annular notch extending around all or part of the circumference of the trunk 16 so as to make it easier to separate the upper head 14 from the lower trunk 16.

According to the invention, the lower trunk 16 can separate from the head 14 such that the head 14 can, after separation, then constitute a display base for the cultured animal.

According to the first embodiment, the upper head and the lower trunk 16 constitute a one-piece support 10 and the separation of the head 14 is an irreversible operation which is carried out when the display base for the cultured animal is likely to be marketed.

The upper head 14 forming the display base is made of a material similar to mineral, such as lightweight, porous natural or artificial stone, so as to form a display base that is similar to the life support of the animal in its natural environment.

The head 14 and/or trunk 16 are for example made by moulding a mixture of one or more mineral components selected from cement, sand, calcium carbonate, calcium hydroxide, pozzolana, natural rock and pumice stone, so as to obtain an artificial stone that looks like natural stone.

Note that the axisymmetric cylindrical shapes, which may be slightly frustoconical, of the head 14 and the trunk 16 respectively, facilitate removal from the mould.

Naturally, a great many shapes may be made, in particular by moulding, and both the top face and the perimeter of the head 14 have for example a natural-looking irregular surface.

The trunk 16 is therefore, according to the first embodiment, advantageously made by moulding as a single piece with the head 14 using a mixture that is similar but of different density and composition, so as to be less mechanically strong and facilitate the subsequent separation of the trunk from the head.

Advantageously, the head 14 includes a plurality of cavities 18 that can receive different animal cuttings 8 which can thus be cultured simultaneously so as to obtain a display base having several aquatic animals, preferably belonging to different species such as for example corals and/or sponges.

FIG. 3 shows an embodiment of an aquaculture installation comprising a culture table 24.

The culture table 24 comprises a generally horizontal tray 26 which has calibrated housings 28 for receiving the cylindrical trunks 16 of the supports 10 according to the invention.

The horizontal tray 26 comprises a frame 30 and a grid 32, each cell of which thus constitutes a housing 28 into which the lower trunk 16 of a support 10 is inserted axially downwards.

Such a horizontal tray 26 is therefore easy to produce and particularly inexpensive owing to the use of a grid 32 to make a structure comprising a plurality of housings 28.

The horizontal tray 26 in this case has legs 34 so as to constitute the culture table 24 that can be fastened to a floor 36, such as the sea floor, by anchoring means 38.

The anchoring means 38 consist for example of a block of concrete secured to the floor 36 and having on its top face a ring for attaching the end of a chain, the other end of which is fastened to one of the legs 34.

Such anchoring means 38 make it possible to ensure that the culture table 24 stays in a fixed position irrespective of sea currents, if the installation is in the natural environment.

As a variant, the culture table 24 is placed in a pond of the installation reproducing the conditions of the natural environment needed for the cultured aquatic animals to develop.

Advantageously, the elements of the installation designed to be immersed in sea water are made of materials that have good corrosion resistance, such as galvanized steel or any other appropriate material.

The legs 34 and the tray 26 of the culture table 24 may be in one piece, for example welded to the frame 30, or made so as to be separable from the tray, for example by removable fastening means.

The tray 26, or a part thereof, may thus constitute a transport tray that can be used on the one hand when the aquatic animals are placed in the installation to be cultured and, on the other hand, at the end of culturing to transport the cultured animals.

As a variant, a tray other than that of the culture table 24 is used for the operations of transporting the animals so that the table 24 of the installation may remain on the floor 36 at the site chosen for the aquaculture.

FIG. 3 shows, from left to right, aquatic animals at various stages of growth, i.e. from the initial cutting 8 until a cultured aquatic animal 2 similar to the “parent” animal shown in FIG. 1 is obtained.

For the transport operations for the purposes of marketing the cultured animals 2, the trunk 16 of the support 10 can be left integral with the head 14 so as to be able to insert the fastening and holding trunk 16 into complementary housings in a handling and transport tray or in a transport container designed for this purpose.

As a variant, the trunk 16 is separated from the head 14 at the end of the culturing so as to allow the assembly consisting of the animal 2 and its display base formed by the head 14 of the support 10 to be packaged.

According to a packaging example (not shown), the display base 14 is attached to a support forming a float, such as a polystyrene support, so as to package the animal 2 for its transport in a package, such as a plastic bag filled with water.

Such a package is usually partly filled with water into which the animal 2 is immersed upside down, i.e. with the branches 6 extending downwards in the opposite direction from the base 14, which is secured to the float.

FIG. 4 shows an aquarium 40 filled with water 42 on whose floor is placed, after separation from the trunk 16, the head 14 of the support 10 forming a display base for the aquatic animal 2.

The animal 2 may thus be set down directly on the underside of its display base, which consists of the horizontal underside of the upper head 14 having the appearance of natural stone, in the aquarium 40, which generally has a sandy floor.

As can be seen in FIG. 4, the base 14 may advantageously be received in a hole 44 of complementary shape made in a natural or artificial rock 46 placed on the floor of the aquarium 40.

The rock 46 may have several holes 44 for the insertion of display bases according to the invention bearing various species of aquatic animals so as to partially reconstruct a reef similar to the natural environment.

An artificial rock 46 may be made by moulding a material similar to that used for the support 10, which is lightweight and porous and has the advantage of not comprising any component likely to react with the water 42 in the aquarium 40, in particular to modify its physicochemical parameters such as its pH.

The aquarium 40 is just one possible example of application for the marketing of a display base 14 bearing a cultured animal 2 according to the invention.

As a variant, the bases and the cultured animals may be used to reconstruct damaged coral beds and/or to create colonies for the development of an aquaculture activity according to the invention.

As a variant, the culture table 24 of the installation according to the invention may be used to produce ornamental artificial stone, such as the rock 46, so that this stone could, owing to its immersion, be used for the culture of bacteria, algae or other microorganisms present in natural sea water.

FIGS. 5 and 6 show a support 10 according to a second embodiment of the invention, which will be described below by comparison with the first embodiment.

The support 10 is advantageously used for the aquaculture by propagation of aquatic animals 2 such as described above and shown in FIG. 1.

In a similar manner, the support 10 therefore comprises an upper head 14 for receiving at least one cutting 8, and a lower trunk 16 for fastening to the support 10, particularly in a culturing installation, or alternatively in a transport container.

According to the second embodiment, the support 10 comprises two separate parts, namely the upper head 14 and the lower trunk 16 which may be, regardless of the number of operations, either assembled together or separated by virtue of connection means between the head 14 and the trunk 16.

Thus, the underside 19 of the head 14 comprises a housing 21 designed to receive, for example, at least part of the lower trunk 16, in this case its upper end.

The trunk 16 is thus easily separated from the head 14 in such a way that the latter subsequently constitutes a display base for the cultured animal 2.

The trunk 16 can be made integral with the head 14 by any appropriate connection means, in particular by collaboration of shapes.

Preferably, the connection between the head 14 and the trunk 16 is achieved by directly fitting the upper end of the trunk 16 in the complementary housing 21 of the head 14.

Such a connection means is particularly simple and inexpensive to produce and makes it possible to quickly and easily connect or separate the two parts of the support 10.

Thus, the upper end of the trunk 16 penetrates the housing 21 of the head until its top face comes into abutment against the end wall of the housing 21.

Preferably, the lower trunk 16 comprises a flange 23 that extends radially outwards and delimits with the outer surface of the lower trunk 16 an upper abutment surface 25 that can collaborate, after assembly of the trunk 16 and the head 14, with the underside 19 of the head 14.

The flange 23 then advantageously constitutes a control means, making it possible to ensure that the trunk 16 is correctly fitted in the head 14 simply by a visual check.

Naturally, as previously, the underside 19 of the head 14 subsequently constitutes the underside of the display base having the appearance of natural stone, which may for example be received in the hole 44 in a natural or artificial rock 46 such as that shown in FIG. 4, or as a variant set down on the sandy floor of an aquarium 40.

Advantageously, the hole 44 in the rock 46 comprises a peg, similar to the trunk 16, that extends vertically upwards from its end wall and that may penetrate the housing 21 of the upper head 14 so as to make it possible to immobilize and/or centre the head 14 in the hole 44, for example.

As a variant, the housing 21 is an orifice that is also open to the top face of the head 14, such that the lower trunk 16 advantageously comprising a flange 23 forming an abutment surface passes through the head 14.

As can be seen in FIG. 6, the lower trunk 16 may be received in the complementary housing 28 of the tray 26 of a culture table 24 forming part of an aquaculture installation.

When, as previously, the tray 26 is of the type having a grid 32 or cross members constituting the cells delimiting the housings 28 for the supports 10, the underside 27 of the flange 23 then advantageously bears axially on the top face 29 so as to axially immobilize the support 10 in the tray 26.

FIG. 7 is a partial schematic perspective view similar to FIG. 5 which shows a variant of the second embodiment.

According to this variant, the lower trunk 16 of the support 10 is integral with the tray 26 so as to constitute a stake extending vertically upwards, to which the upper head 14 is attached, for example by fitting.

Preferably, the lower trunks 16 forming stakes, which are integral with the top face of a plate forming the horizontal tray 26 delimited by the frame 30, in this case do not comprise a flange 23, such that the upper end of the trunk 16 penetrates the housing 21 in the underside 19 of the head 14 until its top face comes into abutment against the upper end wall of the housing 21.

As a variant, when the tray 26 is of the type described and shown in FIG. 5, the lower trunks 16 forming stakes are integral with the cross members 32 and are advantageously placed at the intersection of two cross members 32.

Naturally, when the support 10 is made according to the first embodiment, the underside 19 of the upper head 14 may comprise, after separation from the lower trunk 16, a stub (not shown) corresponding to the residual part of the trunk 16 axially included between the zone 20 of the break initiator 22 and the underside 19 that subsequently constitutes the underside of the display base.

The stub thus extends axially downwards, projecting from the underside 19 such that it can penetrate a complementary housing made in the end wall of the hole 44 in the rock 46 receiving the display base for the aquatic animal 2 that has grown from the cutting 8.

The collaboration between the stub and the housing makes it possible to immobilize and/or centre the head 14 in the hole 44, for example.

When the head 14 of the support 10 forming the display base is placed on the sandy floor of an aquarium 40, the presence of such a stub is inconsequential. However, if it is desired for the underside of the base to be generally flat and horizontal, it is possible to grind the underside 19 to get rid of the stub, for example using a grinding wheel.

Naturally, in the second embodiment, the connection by fitting between the upper head 14 and lower trunk 16 is given solely by way of non-limiting example, it being possible for this connection to also be achieved for example by screwing or snap-fastening.

Thus, when the head 14 and the trunk 16 are connected by collaboration of shapes, these two parts of the support 10 can be connected directly or indirectly with the interposition of complementary connecting elements, such as inserts, which are advantageously integral with the head 14 or the trunk 16.

The complementary shapes for reversible assembly may fit together elastically, for example by means of elastic clips.

According to another variant (not shown), the upper head 14 and the lower trunk 16 may be assembled reversibly by screwing.

A tapped element, such as a bolt or a screw cap, forming the female part, is for example inserted in the housing 21 in the underside 19 of the head 14 and preferably secured to the latter, for example by adhesive bonding, or alternatively when it is made by moulding as described above.

The trunk 16 consists for example of a threaded rod or the upper part of a bottle comprising the neck, and at its upper end it has a complementary thread designed to collaborate with the tapped element.

Preferably, the means for connection by screwing are made of materials that have good corrosion resistance, such as galvanized steel or any other appropriate material, such as plastic.

Naturally, when the lower trunk 16 is likely to constitute a grip part it is then preferably made as an axisymmetric cylinder, such as that shown in the figures.

As a variant, the lower trunk 16 may be made in other geometric shapes, particularly frustoconical, especially when the trunk 16 is integral with the tray 26.

1. Support (10) for the aquaculture, by propagation, of aquatic animals (2), particularly for aquariums, such as cnidarians or poriferans, characterized in that it comprises an upper head (14), for receiving at least one cutting (8), and a lower trunk (16) for fastening the support (10), particularly in a culture installation, or alternatively in a transport container, and in that the trunk (16) can be separated from the head (14) so that the latter then constitutes a base for displaying the cultured animal.

2. Support according to claim 1, characterized in that at least the upper head (14) forming a display base is made of a material similar to mineral.

3. Support according to claim 1, characterized in that the top face of the head (14) comprises at least one cavity (18) for receiving at least one cutting (8) of the animal (2).

4. Support according to claim 3, characterized in that the cutting (8) is fastened in the cavity (18) of the head (14) by fastening means (12), by adhesive bonding, in particular by an epoxy adhesive, a cyanoacrylate or quick-setting cement.

5. Support according to claim 1, characterized in that at least the head (14) is made by moulding a mixture of one or more mineral components selected from cement, sand, calcium carbonate, calcium hydroxide, pozzolana, natural rock and pumice stone.

6. Support according to claim 1, characterized in that it comprises connecting means between the upper head (14) and lower trunk (16) to allow their assembly.

7. Support according to claim 1, characterized in that, on its underside (19), the head (14) comprises a housing (21), in particular for receiving the lower trunk (16).

8. Support according to claim 7, characterized in that the lower trunk (16) comprises a radial flange (23), comprising an upper abutment surface (25) that collaborates after assembly with the underside (19) of the head (14).

9. Support according to claim 1, characterized in that the head (14) has the overall shape of a disc whose horizontal underside, from which the trunk (16) extends centrally downwards, subsequently constitutes the underside of the base.

10. Support according to claim 9, characterized in that the support comprises a zone (20) of lower mechanical strength at the join between the upper end of the trunk (16) and the head (14).

11. Support according to claim 10, characterized in that it comprises a break initiator (22) at the join between the upper end of the trunk (16) and the head (14).

12. Support according to claim 10, characterized in that the trunk (16) is made by moulding as a single piece using a mixture that is similar but of different density and composition, so as to facilitate the subsequent separation of the trunk (16) from the head (14).

13. Installation for the aquaculture, by propagation, of aquatic animals, particularly for aquariums, such as cnidarians or poriferans, of the type comprising at least one support (10) according to claim 1, characterized in that it comprises at least one generally horizontal tray (26) that has at least one housing (28) for receiving a trunk (16) of a support (10).

14. Installation according to claim 13, characterized in that the horizontal tray (26) comprises a frame (30) and a grid (32), each cell of which constitutes a housing (28) for a trunk (16) of a support (10).

15. Installation according to claim 14, characterized in that the lower trunk (16) of the support (10) is integral with the horizontal tray (26).
